(19) United States
(12) Patent Application Publication
(10) Pub. No.: US 2008/0141818 A1
(43) Pub. Date: Jun. 19, 2008

(54) Brake actuator

(76) Inventor: Werner Schadler, Leibnitz (AT)

Correspondence Address: HARNESS, DICKEY & PIERCE, P.L.C., P.O. BOX 828, BLOOMFIELD HILLS, MI, 48303, US

(21) Appl. No.: 12/001,756

(22) Filed: Dec. 12, 2007

(30) Foreign Application Priority Data
Dec. 13, 2006 (DE) 10 2006 058 836.3

(51) Int. Cl. B60T 11/04; B60T 13/74

(52) U.S. Cl. 74/501.5 R

(57) ABSTRACT

A brake actuator for the actuation of a mechanical brake of a motor vehicle having at least one output device. The output device is made for the tightening of a pulling means engaging at the brake, with the pulling means cooperating with the output device at an effective pivot point for each rotary position of the output device. The output device has a design such that, on a rotation of the output device at a constant angular speed, the pulling means experiences a variable tightening speed.

### CROSS-REFERENCE TO RELATED APPLICATIONS

This application claims the benefit of German Patent Application No. 10 2006 058 836.3, filed Dec. 13, 2006. The disclosure of the above application is incorporated herein by reference in its entirety.

### FIELD

The present disclosure relates to an actuator for the actuation of a parking brake, in particular of an electromechanical parking brake of a motor vehicle, that has at least one output device (output drive device) which may be rotated around an axis and is made for the tightening of a pulling means engaging at the brake, for example a wire of a Bowden cable or of a steel band, for the actuation of the brake of the motor vehicle.

### BACKGROUND

The statements in this section merely provide background information related to the present disclosure and may not constitute prior art.

Conventionally, the parking brake of a motor vehicle is activated in a purely mechanical manner by the actuation of a hand lever, with a pulling means in the form of a wire being coiled up onto a disk-shaped circular output element (output drive element). A pulling force is generated by this coiling up of the wire and the associated vehicle brake is ultimately activated by the pulling force. Alternatively, electromechanical parking brakes are also known in which the pulling means is coiled up with the help of an electric motor.

In this conventional embodiment of the output element in the form of a circular disk, the shortening of the wire is substantially proportional to the rotation of the output element. Furthermore, the pulling force that may be applied to the wire with a predetermined torque is constant. Since, however, a comparatively large shortening of the wire can be achieved with a comparatively small pulling force on the tightening of a parking brake, for instance during the first two thirds of the tightening time, whereas the wire is only still shortened by a comparatively small amount while applying a comparatively large pulling force toward the end of the tightening time, the approach using circular disk-shaped output elements only satisfies the demands made on a parking brake to a limited extent.

To satisfy the force requirement, which varies with the tightening time, it was proposed in the past, for example, to operate the parking brakes via motor-controlled (twin) spindles. This approach is, however, comparatively complex, correspondingly expensive and prone to error from a technical aspect so that there is a need for an improved actuator for the actuation of an (electro)mechanical brake of a motor vehicle.

In addition, it may alternatively and/or additionally be desirable to compensate any asymmetries between left and right which may occur, for example, due to an asymmetrical or off-center installation of the brake actuator in a motor vehicle.

### SUMMARY

The present disclosure provides an actuator for the actuation of a mechanical brake of a motor vehicle with which differently large shortenings of the wire may be achieved during the tightening of the brake with a predetermined torque and/or rotational speed. There is in particular a need for a brake actuator with which a shortening of the wire can be achieved with a predetermined torque and/or rotational speed at the start of the tightening time and a different shortening of the wire may be achieved with the same torque and/or rotational speed toward the end of the tightening time in order thus either to be able to satisfy the force requirement, which increases over the tightening time, on the tightening of the brake and/or to be able to compensate any asymmetries.

The actuator includes at least one rotatable output device that has a design such that, on a rotation of the output device at a constant angular speed, the pulling means experiences a variable pulling speed.

This may also be achieved by a suitable shape of the output device such that the pulling speed, and thus the shortening of the pulling element, is comparatively large at the start of the tightening time with a predetermined torque that acts on the output device (drive torque of the electric motor). On the other hand, it may be achieved by a suitable design of the output device such that only a small pulling speed acts on the pulling means toward the end of the tightening time, but instead comparatively high pulling forces. A finely stepped dosing of the braking effect may be achieved in the desired form in this manner.

The desired effect, according to which differently sized shortenings of the pulling means should be adopted at different times during the tightening of the brake, is in particular achieved in that an effective lever arm, which corresponds to the radius between the axis of rotation of the output device and the effective pivot point of the pulling means at the output device, has a different length for different rotational positions. In the case of a winding up of a flexible pulling means on the output device, that point is to be understood as the effective pivot point at which the pulling means rises from the output device in the tangential direction. In this process, the pulling means generally extends orthogonally to the named effective lever arm.

So that effective lever arms of such different lengths may be adopted, the output device may, for example, have a convexly arched receiving track that is specifically designed to be able to accept or wind up the pulling means thereon. The arching of the receiving track may have a varying curvature and thus a varying winding radius. The pulling means is guided tangentially up to the receiving track of the output device, whereby it is actuated at a high pulling speed at points with a large winding radius and, vice versa, at a lower pulling speed at points with a small winding radius. A continuous transition may be realized by the corresponding variation of the curvature or of the winding radius between the first actuation phase (high or low pulling speed, low or high pulling force) and the second actuation phase (low or high pulling speed, high or low pulling force).

Where reference is made in the context of the present disclosure to a “winding up” or “coiling up” of the pulling means, no full revolution of the named output device has to be provided in this connection, but the winding up may also take place along a limited angle of rotation.

To be able to ensure a transition which is as continuous as possible between the high pulling speeds, at the start of the tightening time for example, and the comparatively low pulling speeds, toward the end of the actuation time for example, the receiving track of the output device may have an oval cross-section, for example, in the form of an ellipse. It may be sufficient in this connection for the receiving track of the output device to be made as an elliptical sector or as a sector of an oval over a center angle of somewhat more than 90°. The maximal or minimal pulling speeds may be achieved in this manner as the result of minimal or maximal winding radii which such an elliptical sector or a sector of an oval has in a region of 90°.

To be able to achieve a variation of the pulling speeds and of the pulling forces associated therewith, alternatively or additionally, the axis of rotation around that the output device rotates on an actuation of the actuator in accordance with the present disclosure may be arranged such that it is disposed eccentrically with respect to the center of the peripheral receiving track for the pulling means. In other words, in this case, the center of the receiving track does not coincide with the axis of rotation of the output device. The center is, therefore, off-axis.

The output device may be made, for example, as a disk with a stepped winding coil as the receiving track, but it has proved to be advantageous to make the output device as a ring with an inner toothed arrangement and an outer periphery (that is, as an annulus gear). The outer periphery of the ring may be used as a receiving track for the winding up of the pulling means by the making of the output device as an annulus gear. The inner toothed arrangement, in contrast, serves to drive the output device in the form of the annulus gear via a toothed wheel driven by an electric gear motor. The toothed wheel meshes in turn with the inner toothed arrangement of the annulus gear for this purpose.

The desired compensation of any geometrical asymmetries that may arise, for example, due to an asymmetrical or off-center installation of the brake actuator in a motor vehicle, may also be achieved in that the pulling means is fastened to a first end of a lever which is pivoted at its second end to the output device. Due to the articulated attachment of the lever to the output device, the lever may be pivoted between a first position and a second position as a result of a rotation of the output device such that the effective lever arm of the pulling means with respect to the axis of rotation has a different length in the first position than in the second position. The lever, therefore, enters into interaction with the output device during a rotation thereof and in particular contacts it during the tightening, whereby the first end of the lever is pivoted radially outwardly, from which an increase in the effective lever arm results.

As can be seen from the preceding paragraph, the lever represents a coupling element between the output device and the pulling means. As long as the lever has, however, still not contacted the output device, it may act as an extension of the pulling means. In this first position of the lever, the effective pivot point of the pulling means at the output device, therefore, corresponds to the pivot point of the second end of the lever at the output device. If, however, the lever is located in the second position and thus contacts the output device, the effective pivot point of the pulling means corresponds to the fastening point of the pulling means at the first end of the lever.

To influence the desired increase in the effective lever arm in a supporting manner, the lever may be radially outwardly curved at its first end with respect to the axis of rotation of the output device. The lever may additionally have a shape specifically matched to the design of the output device to be able to have contact at least in the region of its second end along a peripheral section of the output device so that it is not subject to any deformation, or is only subject to small deformations, during the tightening of the brake.

Since (electro)mechanically actuable parking brakes which should be actuated using the actuator in accordance with the present disclosure consist of at least two brakes that act on the two wheels of an axle of a motor vehicle, a compensation of geometrical asymmetries and/or of the pulling forces that are required for the actuation of the two wheel brakes is desired in some cases.

The actuator, therefore, may have two output devices that may be driven by means of a common power source (e.g. electric motor) in an opposite rotary movement, with a force compensation or a length compensation being possible between the output devices or the pulling means attached thereto.

The two output devices may have different effective lever arms (different radii between the respective axis of rotation and the instantaneously effective pivot point of the pulling means) in the starting position (brakes released) and/or in the operating position (pulling means applied). Different pulling forces may namely hereby be effected at the two pulling means, for example to compensate different effective degrees of Bowden cables. The main axles of two oval output devices may, for example, be offset to one another by a predetermined angle of rotation in the starting position of the actuator or the already mentioned levers pivoted at the output devices are made differently.

An actuator for the actuation of two members by means of pulling forces having a power source and two parts rotating in opposite senses around an axis is already known for the establishment of the named force compensation. Such an actuator is described, for example, in WO 2006/066295. Respective pulling elements are associated with both parts of this actuator rotating in opposite senses for the actuation of the members on which oppositely directed pulling forces act between which a compensation should take place, with the parts rotating in opposite senses being two different rings having an inner toothed arrangement that respectively mesh with a toothed zone of toothed elements such as spur gears which are in turn connected to the power source. Reference is made to WO 2006/066295 with respect to further details and in particular with respect to the specific design embodiment of this actuator.

Accordingly, the actuator of the present disclosure in accordance with another embodiment is characterized by a further (second) rotatable output device which is likewise suitable for the tightening of a pulling means attached thereto, with this further pulling means acting in the opposite direction to the first pulling means and is made for the actuation of another member, that is of another brake. This further output device is made similar to the output device explained above, with the further output device being able to be differently shaped or to have a different effective lever arm in comparison with the first-named output device to achieve the desired length compensation or force compensation. To achieve the desired length compensation or force compensation between the two output devices or the pulling means attached thereto, the two output devices are coupled to one another via at least one toothed element meshing with respective inner toothed arrangements. The tooth ratios of the two output devices should be different in order to be able to effect a relative rotation of the two output devices by means of a common drive shaft, i.e. the ratios of the tooth numbers of the respective inner toothed arrangement and of the associated outer toothed arrangement should be selected to be different.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 illustrates a schematic sketch of a vehicle axle with the actuator in accordance with the present disclosure;

FIGS. 2a and 2b illustrates a respective side view of a first embodiment of an output device;

FIG. 3 illustrates a side view of a second embodiment of an output device in a first position;

FIG. 4 illustrates the output device of FIG. 3 in a second position; and

FIGS. 5 and 6 illustrate a schematic representation of an actuator in accordance with the invention with two output devices for the force compensation.

### DETAILED DESCRIPTION

The following description is merely exemplary in nature and is not intended to limit the present disclosure, application, or uses. It should be understood that throughout the drawings, corresponding reference numerals indicate like or corresponding parts and features.

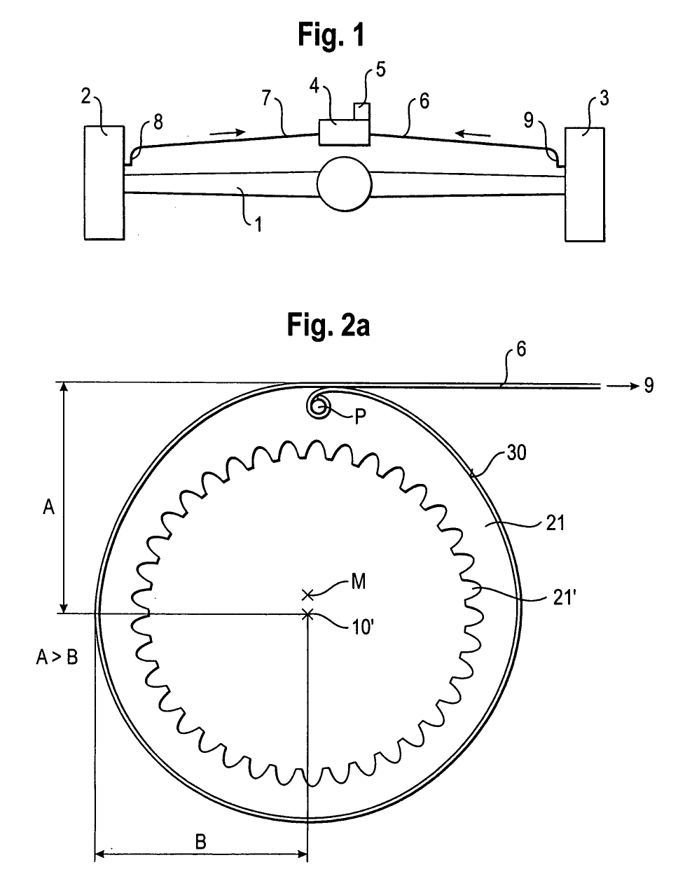

In FIG. 1, the axle of a motor vehicle is indicated and marked by 1; its left wheel is marked by 2 and its right wheel by 3. Pulling means (wires or Bowden cables) 6, 7 lead from an actuator 4 having a power source 5 to the members to be actuated, here brake levers 8, 9, with which wheel brakes, not shown, may be actuated as simultaneously as possible and with the same force.

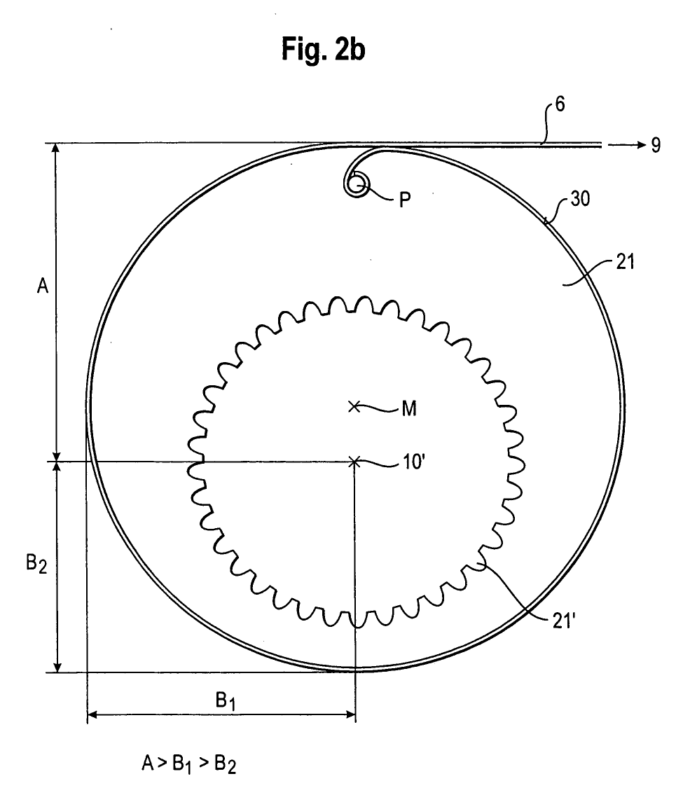

In FIG. 2a, an output device 21 of the actuator is shown in elevation. The output device 21 may be made as an annulus gear and have an oval shape, which may in particular be read off due to the dimensioning, according to which the winding radius A is larger than the winding radius B offset at an angle of 90° thereto. The oval output device 21 is provided at its inner periphery with an inner toothed arrangement 21′ which is not oval, but extends along a circular line and which is concentric to the axis of rotation 10′ of the output device 21. The output device 21 forms a receiving track 30 at the outer periphery and the pulling means 6, which is in turn attached to the output device 21 at the fastening point P, may be wound on to the receiving track. The center M of the oval receiving track 30 is offset (off-axis) with respect to the axis of rotation 10′.

The pulling means 6 leads to the brake lever 9, as FIG. 2a shows. In FIG. 2a, the output device 21 is in a position at the start of the tightening time. If the output device 21 is now rotated via the inner toothed arrangement 21′ counterclockwise around the axis 10′ with the help of a gear motor not shown here and with a toothed wheel driven thereby, this has the result that a pulling force is applied to the pulling means 6 for the actuation of the brake lever 9. At the start of the actuation time, the torque applied is converted via the effective lever arm “A” into a pulling force component in the pulling means 6. As a result of the rotation of the output device 21 counterclockwise, this effective lever arm becomes smaller and smaller up to a rotation of 90° so that the effective lever arm only has the magnitude B after a rotation of 90°. The reduction in the effective lever arm from A to B has the result that the pulling means 6 is tightened comparatively fast at a predetermined angular speed of the output device 21 at the start of the tightening time, whereas it is only tightened comparatively slowly in a position rotated counterclockwise by 90°. On the other hand, the comparatively large lever arm A is sufficient at the start of the tightening time to overcome the brake lever force still not very large at this point in time. The braking force to be applied, however, constantly increases toward the end of the tightening time. This increase in the braking force is taken into account with the reduction in the effective lever arm which only has the magnitude B after a 90° rotation so that larger pulling forces may be applied with a predetermined torque via the effective lever arm B.

As may be seen from the preceding statements, it is sufficient to make the receiving track 30 for the winding up of the pulling means 6 only regionally in the form of a portion from an ellipse or in the form of an oval.

Alternatively to the making of the receiving track 30 of the output device 21 in the form of an oval, the output device 21, including the receiving track 30, may, however, also be made in circular fashion and only the inner toothed arrangement 21 or the axis of rotation 10′ are arranged eccentrically to the center M of the circular output device 21, as is shown in FIG. 2b. It is namely only important that the effective lever arm, measured from the center of rotation 10′ toward the effective pivot point, at which the pulling means 6 releases from the outer periphery of the output device 21 or from the receiving track 30, changes on a rotation of the output device 21.

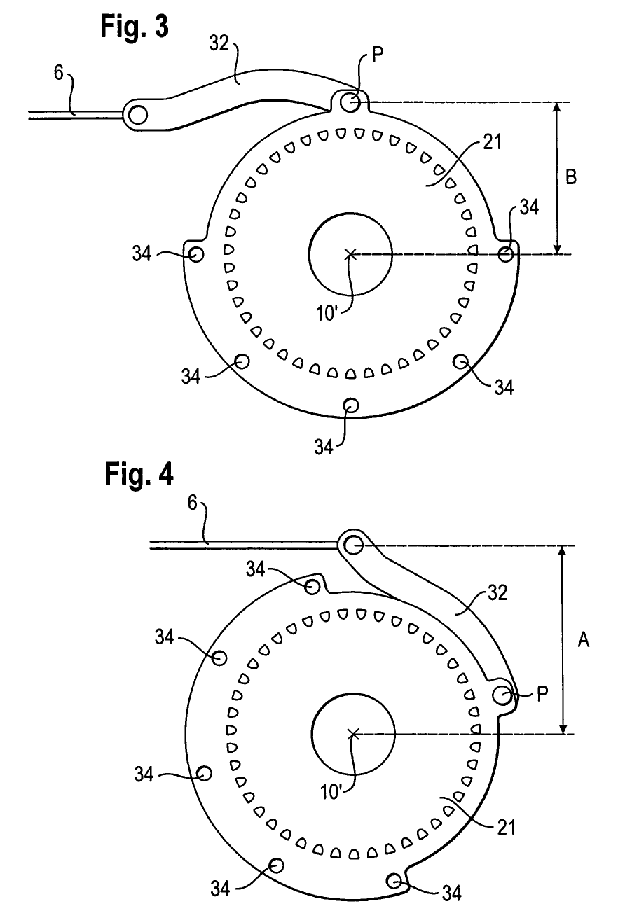

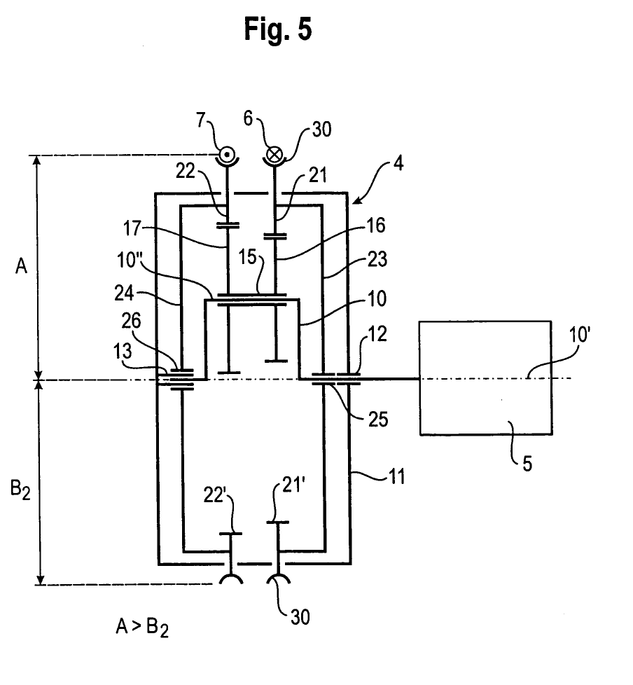

Another output device 21 of the actuator is shown in FIGS. 3 and 4. The output device 21 is made in disk shape and substantially has two oppositely disposed semi-circular disk sections with different radii. Five fastening openings 34 via which the output device 21 may be fastened, for example, to an annulus gear are formed at a regular pitch in the semi-circular disk portion of larger diameter.

A slightly S-shaped lever 32 is hingedly attached to a pivot point P of the output device 21 at a side of the output device 21 disposed opposite the middle fastening opening 34. A pulling means 6 is fastened to the free end of the lever 32 so that, if the output device 21 is subjected, for example, to a clockwise rotation with the help of a gear motor (not shown), a pulling force may be applied to the pulling means for the actuation of a brake lever.

As may be seen from FIG. 3, the pulling means 6 is aligned there as a consequence of the pulling force action such that its line of action is aligned directly in the direction of the pivot point P of the output device 21 so that the effective lever arm B is represented by the spacing between the axis of rotation 10′ and the pivot point P.

If, as a result of a clockwise rotation, the application of a pulling action on the pulling means 6 is continued for the actuation of a brake 9, this has the result that the free end of the lever 32 moves ever closer to the smaller semicircular section of the output device 21, on the one hand. When the section of the lever 32 which is concave with respect to the output device 21 contacts the outer periphery of the smaller semicircular disk section of the output device 21 and when the rotation of the output device 21 is moved further on, this has the result that the effective lever arm A is to be measured between the axis of rotation 10′ and the free end of the lever 32, with the effective lever arm A being able to be larger with a corresponding shape of the lever 32 than the lever arm B at the start of the tightening time.

This may in particular be achieved in that the lever 32 is curved radially outwardly at its free end with respect to the axis of rotation 10′ so that ultimately, in the state in accordance with FIG. 4, the effective pivot point of the pulling means 6 at the output device 21 corresponds to the fastening point of the pulling means 6 at the free end of the lever 32 and the effective lever arm A has a larger length than the effective lever arm B at the start of the tightening time.

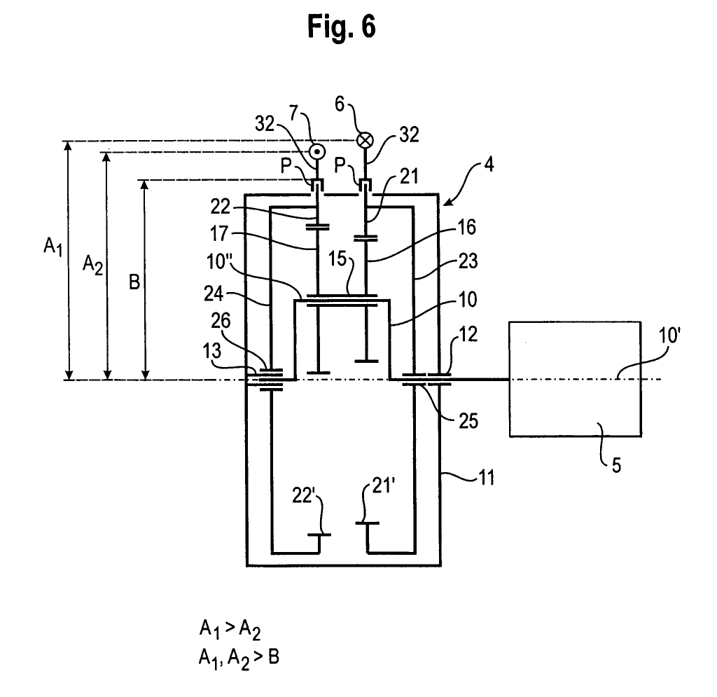

Referring to FIG. 5, the basic principle of an actuator with two output devices 21, 22 will be described with the help of which a force compensation can be effected for the uniform actuation of two parking brakes. The output devices 21, 22 shown in FIG. 5 correspond to the output devices 21 as were previously described with reference to FIGS. 2a and 2b.

In FIG. 5, an eccentric shaft 10 acting as a planet carrier directly adjoins an electric motor 5. The eccentric shaft 10 is supported in bearings 12, 13 with respect to a non-rotatable housing 11. Its axis, and thus the main axis of the actuator 4, is marked by 10′, its eccentric axle by 10″. A toothed element 15 is rotatably supported on this eccentric axle 10″. It consists here of a first toothed wheel 16 and a second toothed wheel 17 which are rotationally fixedly connected to one another. Expressed in more general terms, the toothed element 15 consists of a first toothed zone 16 and a second toothed zone 17, of which the first 16 meshes with a first ring 21 with an internal toothed arrangement 21′ in the form of an output device in accordance with the invention and the second 17 meshes with a second ring 22 with an internal toothed arrangement 22′ likewise in the form of an output device in accordance with the invention. The rings or output devices 21, 22 are each supported at the eccentric shaft 10 via a disk 23, 24 and bearings 25, 26. The double planetary gears 16, 17 as well as the annulus gears 21, 22 are dimensioned in different sizes, which has the result of different ratios of the tooth numbers of the respective inner toothed arrangement and of the associated planetary gear.

The actuator thus forms an eccentric epicyclic transmission consisting of a planet carrier 10″, one or more double planetary gears 16, 17 distributed over the periphery and two annulus gears 21, 22. The annulus gears 21, 22 are made in the form of the output devices previously described with reference to FIGS. 2a and 2b and having an off-axis center of the receiving tracks 30 in groove shape here. As can be seen from FIG. 5, a varying winding radius of the pulling means 6, 7 (varying spacing of the respective engagement point from the axis of rotation 10′) is hereby realized. Deviating from the representation in accordance with FIG. 5, the receiving tracks 30 naturally do not have to project out of the housing 11 provided that the pulling means 6, 7 are otherwise guided out therefrom, for example through openings in the housing.

While referring to FIG. 6, finally the basic principle of an actuator with two output devices 21, 22 will be described which substantially correspond to the output devices 21, 22 previously described with reference to FIGS. 3 and 4, with the actuator being structured in another respect analogously to that of FIG. 5 so that reference can be made thereto in this respect.

Deviating from the output devices 21, 22 shown in FIGS. 3 and 4 the output devices 2, 22 are here made as annulus gears with inner toothed arrangements 21′ and 22′ which mesh with the toothed gears 16, 17 analogously to the embodiment of FIG. 5.

As can be seen from FIG. 6, the two output devices 21, 22 project out of the housing 11 through corresponding openings so that the levers 32 are only pivoted at the fastening points P of the two output devices outside the housing 11. The levers 32 can, however, naturally also extend into the interior of the housing 11 to hinge the pulling means 6, 7 to the output devices 21, 22 there.

In FIG. 6, it is shown for the rotary position of the respective output device 21, 22 corresponding to FIG. 4 that different effective lever arms A1 and A2 are realized for the pulling means 6, 7 due to different shapes of the two levers 32. In the example shown, a higher pulling force is thus achieved for the pulling means 7 at the same torque than for the pulling means 6 (A₁>A₂).

In addition, an effective lever arm B is drawn in FIG. 6 which would apply to both pulling means 6, 7 in the rotary position of the output devices in accordance with FIG. 3.

What is claimed is:

1. A brake actuator for the actuation of at least one parking brake of a motor vehicle, comprising:
at least one rotatable output device for the tightening of a pulling means engaging at the brake, with the pulling means cooperating with the output device at an effective pivot point for each rotary position of the output device,
wherein the output device has a design such that, during rotation of the output device at a constant angular speed, the pulling means experiences a variable tightening speed.

2. The actuator in accordance with claim 1, wherein an effective lever arm, which corresponds to a radius between an axis of rotation of the output device and the effective pivot point, has a different length for different rotary positions.

3. The actuator in accordance with claim 1, wherein the pulling means is wound along a receiving track of the output device.

4. The actuator in accordance with claim 3, wherein the receiving track has a varying curvature.

5. The actuator in accordance with claim 3, wherein a cross-section of the receiving track corresponds at least sectionally to an oval or an ellipse in a plane normal to an axis of rotation of the output unit.

6. The actuator in accordance with claim 3, wherein the output device has an axis of rotation which is offset with respect to a center of the receiving track.

7. The actuator in accordance with claim 5, wherein the axis of rotation of the output device coincides with a center of the oval or of the ellipse.

8. The actuator in accordance with claim 1, wherein the pulling means is fastened to a first end of a lever whose second end is pivoted at the output device to be pivotable between a first position and a second position as a result of a rotation of the output device, with the effective lever arm of the pulling means with respect to an axis of rotation of the output device having a different length in the first position than in the second position.

9. The actuator in accordance with claim 8, wherein the effective pivot point of the pulling means at the output device in the first position of the lever corresponds to the pivot position of the second end of the lever at the output device and, in the second position of the lever, corresponds to the fastening point of the pulling means at the first end of the lever.

10. The actuator in accordance with claim 8, wherein the lever is radially outwardly curved at its first end with respect to the axis of rotation of the output device.

11. The actuator in accordance with claim 1, wherein the output device is driven by means of an electric motor.

12. The actuator in accordance with claim 1, further comprising another rotatable output device which is made for the tightening of another pulling means attached thereto and acting against the pulling means of the one output device for the actuation of another brake, with the further output device being made in accordance with the one output device and with the one output device being coupled with the further output device kinematically via at least one toothed wheel meshing with respective inner toothed arrangements such that a force compensation takes place between the pulling means.

13. The actuator in accordance with claim 12, wherein the ratios of the tooth numbers of the respective inner toothed arrangements off the output devices and of the associated toothed wheel are different.

14. The actuator in accordance with claim 8, further comprising another rotatable output device for the tightening of another pulling means attached thereto and acting against the pulling means of the one output device for the actuation of another brake, with the further output device being made in accordance with the one output device and with the one output device being coupled with the further output device kinematically via at least one toothed wheel meshing with respective inner toothed arrangements such that a force compensation takes place between the pulling means.

15. The actuator in accordance with claim 14, wherein the respective radius between the axis of rotation of the output device and the effective pivot point is different for the two output devices in the second position of the respective lever.
